(19) United States
(12) Patent Application Publication
(10) Pub. No.: US 2026/0018714 A1
(43) Pub. Date: Jan. 15, 2026

(54) Cylindrical Battery Cell Housing with a Low CO2 Footprint

(71) Applicants: Martin Christoph Lentz, Bonn (DE); Holger Aretz, Spessart (DE); Waldemar Krieger, Düsseldorf (DE)

(72) Inventors: Martin Christoph Lentz, Bonn (DE); Holger Aretz, Spessart (DE); Waldemar Krieger, Düsseldorf (DE)

(73) Assignee: Speira GmbH, Grevenbroich (DE)

(21) Appl. No.: 19/337,093

(22) Filed: Sep. 23, 2025

Related U.S. Application Data
(63) Continuation of application No. PCT/EP2024/058558, filed on Mar. 28, 2024.

(30) Foreign Application Priority Data
Apr. 3, 2023 (EP) 23166400.4

(51) Int. Cl. H01M 50/119; H01M 50/107

(52) U.S. Cl. CPC H01M 50/119; H01M 50/107

(57) ABSTRACT

The invention relates to a cylindrical battery cell housing having an aluminium material as well as a method for manufacturing a cylindrical battery cell housing and a use of an aluminium material for manufacturing a cylindrical battery cell housing. The object of providing a cylindrical battery cell housing with a reduced CO₂ footprint compared to the current reference material steel, which simultaneously enables improved heat conduction and a lower weight of the battery cell, is achieved for the cylindrical battery cell housing by the fact that the cylindrical battery cell housing has an aluminium material, with a ratio of the amount of carbon dioxide (CO₂ₑ) emitted during the manufacture of the aluminium material in kg_{CO2e} per kg Al material to the yield strength R_{p0.2} of the aluminium material in MPa of CO₂ₑ/R_{p0.2} is ≤1.9% kg_{CO2e}/(MPa*kg_{Al-material}).

### CROSS-REFERENCE TO RELATED PATENT APPLICATIONS

This patent application is a continuation of International Application No. PCT/EP2024/058558, filed on Mar. 28, 2024, which claims the benefit of priority to European Patent Application No. 23166400.4, filed Apr. 3, 2023, the entire teachings and disclosures of both applications are incorporated herein by reference thereto.

### FIELD OF THE INVENTION

The invention relates to a cylindrical battery cell housing having an aluminium material as well as a method for manufacturing a cylindrical battery cell housing and a use of an aluminium material for manufacturing a cylindrical battery cell housing.

### BACKGROUND OF THE INVENTION

Battery cells may essentially be differentiated into primary cells, which can only be discharged once and cannot be recharged, and secondary cells, which are rechargeable. The necessary electrochemical processes that provide the functionality of the battery cell may be implemented with a wide variety of different materials in both primary and secondary cells. Examples of primary cells in this context are alkali-manganese cells, zinc-carbon cells, nickel oxyhydroxide cells or lithium/iron sulphide cells, to name just a few. Examples of secondary cells are lithium-ion cells, sodium ion cells, nickel-cadmium cells, nickel/metal hydride cells or nickel-zinc cells, to name just a few.

For a number of years, lithium-ion secondary cells have increasingly been used particularly in the fields of electromobility and consumer electronics, among other things because of their comparatively high gravimetric and volumetric energy densities. Like other types of battery cells, lithium-ion secondary cells have a battery cell housing. This forms the outer shape of the battery cell and encloses a cavity, which contains among other things the anode material, the cathode material and an electrolyte. A distinction may be made between various designs of a battery cell housing: cylindrical battery cell housings essentially have the shape of a cylinder. If the height of the cylinder is greater than the diameter, they are referred to as round cells, otherwise as button cells. Battery cell housings of prismatic design essentially have the shape of a prism, in particular a cuboid. Another variant is the pouch design, in which the battery cell housing essentially has the shape of a pocket or pouch.

Owing to high requirements for strength and mechanical stability as well as high requirements for electrochemical stability in relation to the electrolyte acting corrosively on the battery cell housing, cylindrical battery cell housings in particular have to date generally been manufactured from nickel-plated steel. The dominant round battery cell format is the type 18650 with a diameter of 18 mm. In various applications, these are being replaced with 21 mm round battery cells of the type 21700. Moreover, substitution of round battery cells of the type 46800 with a diameter of 46 mm for round battery cells of the type 21700 is already to be expected, for example in the field of electromobility. The increasing cell formats are placing greater demands on the removal of the heat generated inside the round battery cell and therefore on the electrical and thermal conductivities of the battery cell housing.

Approaches with the use of aluminium alloys for cylindrical battery cell housings are already known, but are limited to the aluminium alloy AA3003. For example, a battery cell housing with an outer diameter of 13.8 mm and a height of 49.0 mm is known from the US patent specification U.S. Pat. No. 6,258,480 B1. The battery cell housing was manufactured by deep drawing and wall-ironing from a round segment of an aluminium alloy sheet consisting of an aluminium alloy of the type AA3003.

Whereas in the case of battery cell housings with smaller cross sections, the mechanical stability of the battery cell housing results essentially from the stiffness of the geometric shape as a cylinder, the yield strength R_{p0.2} of the material of the battery cell housing plays an increasing role in the case of larger cross sections of the round battery cells beyond an outer diameter of 15 mm. In terms of mechanical strength, nickel-plated steel, which is known per se as a material for battery cell housings, is to be regarded here as a reference. A typical yield strength R_{p0.2} of 350 MPa is assumed for nickel-plated steel strips of the type AISI 1020.

The use of lithium-ion secondary cells for storing electrical energy is a key technology in combating global climate change, as it enables highly efficient and economical storage of electrical energy. At the same time, the production of lithium-ion secondary cells causes greenhouse gas emissions which are quantified via CO₂ equivalents (CO₂ₑ). If greenhouse gas emissions or greenhouse gas emissions are referred to in the following, they therefore always refer to their CO₂ equivalents (CO₂ₑ). According to a European battery manufacturer from 2021, around 10% of greenhouse gas emissions are caused by the provision of the mechanical components of a battery cell alone, in particular the battery cell housing.

For the nickel-plated steel strips previously used for cylindrical battery cell housings, a value of 2.4 kg_{CO2e}/kg_{St} for greenhouse gas emissions is known from the literature. However, steel has a density of 7.80 g/cm³ compared to 2.7 g/cm³ for aluminium. Compared to steel, aluminium has the disadvantage of lower strength and a higher CO₂ footprint per kg, which is the average for primary metal at 8.6 kg_{CO2e/kgAl-material} for primary metal consumed in the EU. Primary aluminium is aluminium that is produced directly from the raw material bauxite or from the clay extracted from it. Since it is produced in aluminium mills, it is also known as molten aluminium. Taking into account the greenhouse gas emissions from the production of the primary metal at 8.6 kg_{CO2e/kgAl-material}, between 3 and 4% of the greenhouse gas emissions from the production of the battery cell housing can currently be attributed to aluminium-based primary material.

However, the plan is to reduce greenhouse gas emissions during the production of the battery cells by a factor of 10 from a current level of around 100 kg_{CO2e/kWh} to around 10 kg_{CO2e/kWh}. As a result, the share of greenhouse gas emissions from the battery cell housing per kWh could increase to up to 30 to 40% of the greenhouse gas emissions of the entire battery cell per kWh when using an aluminium material, provided that the share of greenhouse gas emissions or the CO₂ equivalents of the battery cell housing is not reduced. On the other hand, the greenhouse gas emissions per kg of the reference material steel are lower, leading to lower shares of the total emissions from the production of the battery cell, but this has significant disadvantages for battery applications, for example in the field of electric vehicles, in terms of the weight and thermal management of the battery cell.

The report “ENVIROMENTAL PROFILE REPORT, Life-Cycle Inventory Data for Aluminium Production and Transformation Processes in Europe, February 2018” (https://european-aluminium.eu/wp-content/uploads/2023/01/European-Aluminium_Environmental-PROFILE-REPORT-2018_full-version.pdf) shows which greenhouse gas emissions are quantified via CO₂ equivalents (CO₂ₑ) in kg_{CO2e}, in the production of aluminium and aluminium alloy products in Europe. The CO₂ equivalents were determined in the report according to the ISO 14040 and 14044 standards. The standards therefore provide a predefined procedure for determining CO₂ equivalents. Identical standards were used for the determination of CO₂ equivalents in other regions, for example for aluminium production in North America in the report “The Environmental Footprint of Semi-Fabricated Aluminium Products in North America, A Life cycle Assessment Report” by the Aluminium Association (https://www.aluminium.org/sites/default/files/2022-01/2022_Semi-Fab_LCA_Report.pdf).

Michael Zotter's thesis entitled “Life-Cycle Analysis of Lightweight Construction Concepts for Automotive Engineering” from the Graz University of Technology in April 2014 is also based on the international standards ISO 14040 and ISO 14044 for determining CO₂ equivalents. In the professional world, CO₂ equivalents are therefore determined according to the two above-mentioned standards.

All CO₂ equivalents in kg_{CO2e} mentioned below therefore refer in particular to CO₂ equivalents in kg_{CO2e} determined in accordance with ISO 14040 and ISO 14044.

### SUMMARY OF THE INVENTION

Based on this, the object of the present invention is to provide a cylindrical battery cell housing with a reduced CO₂ footprint compared to the current reference material, which simultaneously enables improved heat conduction and a lower weight of the battery cell. In addition, a method for manufacturing the battery cell housing is to be specified and an aluminium material for use in the manufacture of cylindrical battery cell housings is to proposed.

According to the invention, the above-mentioned object of a cylindrical battery cell housing having an aluminium material is achieved by the cylindrical battery cell housing having an aluminium material with a ratio of the amount of carbon dioxide (CO ₂ₑ) emitted during the manufacture of the aluminium material in kgCO₂ₑ per kg_{Al-material} to the yield strength R_{p0.2} of the aluminium material in MPa of

CO₂ₑ/R_{p0.2}≤1.9% kg_{CO2e}/(MPa*kg_{Al-material}),
preferably CO₂ₑ/R_{p0.2}≤1.8% kg_{Co2e}/(MPa*kg_{Al-material}),
more preferably CO₂ₑ/R_{p0.2}≤1.6% kg_{CO2e}/(MPa*kg_{Al-material}),
particularly preferably CO₂ₑ/R_{p0.2}≤1.2% kg_{CO2e}/(MPa*kg_{Al-material}) or
CO₂ₑ/R_{p0.2}≤1.0% kg_{CO2e}/(MPa*kg_{Al-material}), whereby the yield strength R_{p0.2} is measured in accordance with DIN EN ISO 6892-1 at room temperature.

It has been shown that an aluminium material with a ratio of CO₂ₑ/R_{p0.2} of a maximum of 1.9% kg_{CO2e}/(MPa*kg_{Al-material}) can achieve a reduction in greenhouse gas emissions in the manufacture of battery cell housings of around 4% compared to the reference material steel, so both a reduction in greenhouse gas emissions for the manufacture of the battery cell housing and a battery cell with improved thermal conductivity at a lower weight can be provided.

The claimed ratio of CO₂ₑ/R_{p0.2} can be used to achieve the saving in greenhouse gas emissions in CO₂ equivalents (CO₂ₑ) per kg of the aluminium material regardless of the aluminium alloy classification and the corresponding design of the cylindrical battery cell. The mechanical properties of the cylindrical battery cell housing specified by the reference material, in this case steel of the type AISI1020 with a yield strength R_{p0.2} of 350 MPa, are taken into account and adhered to.

FIG. 1 shows a schematic view of a cylindrical battery cell housing with a length 1 and an outer radius R. The battery cell housing consists of a battery cell housing jacket and two battery cell housing lids. The wall thickness of the aluminium material is designated as s. At least one of the lids and the jacket can have different wall thicknesses, which are specified based on the internal pressure stability of the battery cell housings. For the sake of simplicity, however, identical wall thicknesses are assumed for both lids. The moving together of two lids with identical wall thickness is used to simplify the calculations, as there is no significant impact on the calculated change in greenhouse gas emissions. In addition, a density of ρ=2.7 g/cm³ is assumed for all aluminium materials.

The cylindrical battery cell housing made of the reference material steel is assumed.

The mass w_{Steel} for the jacket surface of the steel version is derived from the following equation, where ρ_{Steel} is the density of steel, 1 is the length of the tube, s_{Steel} is the wall thickness of the steel housing and Rᵢ is the inner radius of the tube:

$${w}_{Steel} = {ρ}_{Steel} * L * π * ( {s}_{Steel}^{2} + 2 * {s}_{Steel} * {R}_{i} ) \qquad ( 1 )$$

Based on Barlow's formula, the mass w_{Alu} of the battery cell housing jacket in the form of an aluminium tube designed for the same flow start as the steel version can be calculated as follows.

### From

$${w}_{Alu} = {ρ}_{Alu} * L * π * ( {s}_{Alu}^{2} + 2 * {s}_{Alu} * {R}_{i} ) \qquad ( 2 )$$

with
ρ_{Alu}: Density aluminium material
s_{Alu}: Wall thickness of the aluminium material
Rᵢ: Inner radius
   follows

$${w}_{Alu} = {ρ}_{Alu} * L * π * ( {( \frac{{R}_{p 0.2 , steel}}{{R}_{p 0.2 , Alu}} * {s}_{steel} )}^{2} + 2 * \frac{{R}_{p 0.2 , steel}}{{R}_{p 0.2 , Alu}} * {s}_{steel} * {R}_{i} ) \qquad ( 3 )$$

The wall thickness s_{Alu} of the aluminium tube, i.e. the battery cell housing jacket, is derived from Barlow's formula and the design compared to the start of flow using the reference voltage according to Tresca as:

$${s}_{Alu} = \frac{{R}_{p 0.2 , steel}}{{R}_{p 0.2 , Alu}} \cdot {s}_{Steel} \qquad ( 4 )$$

The mass w_{Steel,D} of the steel lid is the product of the circular surface of the lid, the wall thickness of the lid and the density of steel:

$${w}_{Steel , D} = π * {R}_{i}^{2} * {s}_{Steel , D} * {ρ}_{St} \qquad ( 5 )$$

For the lid of the cylindrical battery cell housing, the internal pressure stability requirement results in a different relationship. Starting from the moving together:

$$\frac{{R}_{p 0.2}}{p} \approx \frac{{σ}_{max}}{p} \qquad ( 7 )$$

where p is the internal pressure in the prismatic battery cell housing and σₘₐₓ is the maximum tension of the lid material according to Tresca, derived from the proportionality of the ratio between tension and pressure at a wall thickness of s for a plate with a normal uniform pressure load acting on the surface (e.g. Dubbel, “Pocket Book of Mechanical Engineering”, 19th edition, Springer Verlag 1997: Chapter C, “Strength gauge”):

$$\frac{{R}_{p 0.2}}{p} ∝ \frac{1}{{s}^{2}} . \qquad ( 8 )$$

When comparing two materials with identical geometry (8)

$${( {s}^{2} \cdot \frac{{R}_{p 0.2}}{p} )}_{Alu} = {( {s}^{2} \cdot \frac{{R}_{p 0.2}}{p} )}_{Steel} \qquad ( 9 )$$

Assuming the reference material AISI1020 with a yield strength R_{p0.2} of 350 MPa at the given wall thickness of the lid, the following follows if the identical internal pressure stability for the wall thickness of the new aluminium material is achieved:

$${s}_{Alu , D} = {{s}_{Steel , {D}^{*}} ( \frac{{R}_{p 0.2 , steel}}{{R}_{p 0.2 , Alu}} )}^{\frac{1}{2}} \qquad ( 10 )$$

The wall thickness of the aluminium lid is determined in such a way that the same resistance against the start of flow is achieved. The mass of the aluminium lid is determined as follows:

$${w}_{Alu , D} = π * {R}_{i}^{2} * {( \frac{{R}_{p 0.2 , steel}}{{R}_{p 0.2 , Alu}} )}^{0.5} * {s}_{Steel , D} * {ρ}_{Alu} \qquad ( 11 )$$

The mass of the steel battery cell housing is then calculated as follows:

$${w}_{Steel , total} = {ρ}_{Steel} * L * π * ( {s}_{Steel}^{2} + 2 * {s}_{Steel} * {R}_{i} ) + 2 * π * {R}_{i}^{2} * {s}_{Steel , D} * {ρ}_{Steel} \qquad ( 12 )$$

The weight of the aluminium housing is determined in the same way:

$${w}_{Alu , tot} = {ρ}_{Alu} * L * π * ( {( \frac{{R}_{p 0.2 , Steel}}{{R}_{p 0.2 , Alu}} * {s}_{Steel} )}^{2} + 2 * \frac{{R}_{p 0.2 , Steel}}{{R}_{p 0.2 , Alu}} * {s}_{Steel} * {R}_{i} ) + {2}^{*} π * {R}_{i}^{2} * {( \frac{{R}_{p 0.2 , steel}}{{R}_{p 0.2 , Alu}} )}^{0.5} * {s}_{Steel , D} * {ρ}_{Alu} \qquad ( 13 )$$

The percentage change in greenhouse gas emissions for the cylindrical battery cell housing results from the use of the products of the respective masses in kg of the battery cell housing and the respective masses in kg of greenhouse gas emissions CO₂ₑ of the respective material:

$$\frac{w * CO {2}_{e , alu} - {w}_{Steel , total} * CO {2}_{e , steel}}{{w}_{Steeltotal * CO {2}_{e , steel}}} = \frac{{w}_{Alu , tot * CO {2}_{e , alu}}}{{w}_{S teel , total * CO {2}_{e , steel}}} - 1 \qquad ( 14 )$$

$$= \frac{( ( {ρ}_{Alu} * L * π * ( {( \frac{{R}_{p 0.2 , steel}}{{R}_{p 0.2 , Alu}} * {s}_{Steel} )}^{2} + 2 * \frac{{R}_{p 0.2 , steel}}{{R}_{p 0.2 , Alu}} * {s}_{Steel} * {R}_{i} ) + {2}^{*} π * {R}_{i}^{2} * {( \frac{{R}_{p 0.2 , steel}}{{R}_{p 0.2 , Alu}} )}^{05} * {s}_{Steel , D} * {ρ}_{Alu} ) * CO {2}_{e , alu} )}{( ( {ρ}_{Steel} * L * π * ( {s}_{Steel}^{2} + 2 * {s}_{Steel} * {R}_{i} ) + 2 * π * {R}_{i}^{2} * {s}_{Steel , D} * {ρ}_{Steel} ) * CO {2}_{e , steel} )} - 1 \qquad ( 15 )$$

with
CO_{2e,alu},CO_{2e,stehl}: mass of CO₂ equivalents emitted in kg_{CO2e} per kg aluminium or steel.

For the aluminium material according to the invention with a ratio of CO₂ₑ/R_{p0.2} of a maximum of 1.9% kg_{CO2e}/(MPa*kg_{Al-material}), the use of a cylindrical battery cell housing of the format 18650 made of steel type AISI 1020 with the wall thicknesses of the tube or s_{Steel}=0.185 mm the lids s_{Steel,D}=0.22 mm and an internal radius Rᵢ=8.815 mm at a length L=65 mm results in a saving of greenhouse gas emissions of more than 4%.

To achieve greater savings in greenhouse gas emissions, the selected aluminium material preferably has a ratio of CO₂ₑ/R_{p0.2} of a maximum of 1.8% kg_{CO2e}/(MPa*kg_{Al-material}), more preferably a maximum of 1.6% kg_{CO2e}/(MPa*kg_{Al-material}), particularly preferably a maximum of 1.2% kg_{CO2e}/(MPa*kg_{Al-material}) or particularly preferably a maximum of 1.0% kg_{CO2e}/(MPa*kg_{Al-material}). As a result, a saving in greenhouse gas emissions of preferably more than 10%, more preferably more than 20%, particularly preferably more than 40% or particularly preferably at least 50% compared to the current reference material steel can be achieved with this battery cell housing format. For larger battery cell formats such as the 21700 or 4680 format, essentially identical values are achieved in terms of the saving of greenhouse gas emissions at the stated ratios CO₂ₑ/R_{p0.2} of the aluminium material.

According to a first embodiment, the cylindrical battery cell housing has a housing jacket with an outer diameter of more than 14 mm, preferably more than 17.5 mm, particularly preferably more than 22 mm, wherein the length of the cylindrical battery cell housing is optionally at least 40 mm. In the case of larger battery cell formats, the aluminium material can particularly well translate its lower weight and significantly better heat conduction into improved battery cell performance. The cylindrical battery cell housing preferably has the formats 18650, 21700, 26105, 4680, 4690 or 46125.

According to a further advantageous embodiment, the aluminium material is an aluminium wrought material. Aluminium wrought materials have the property of permitting high degrees of forming, as is necessary for the manufacture of cylindrical battery cell housings. At the same time, they provide a very dense microstructure compared to cast aluminium materials, so that the impermeability requirements of the cylindrical battery cell housings can also be met.

A preferred heat-treatable aluminium networking material is provided by aluminium alloys of type AA6xxx. These can be extruded into a battery cell housing jacket in the form of a cylindrical tube, which can provide the battery cell housing equipped with two battery cell lids. This enables an economical manufacturing process to be provided.

Naturally hard aluminium wrought materials can be manufactured with simpler manufacturing processes compared to heat-treatable aluminium wrought materials, which can also generally be associated with lower greenhouse gas emissions, since, for example, high annealing steps such as those required for solution annealing of heat-treatable alloys, can be avoided, particularly at the final thickness. With regard to thermal joining processes such as welding the cylindrical battery cell housings, the naturally hard aluminium materials have a significantly lower tendency to decrease in strength and generally possess good corrosion resistance. The naturally hard aluminium materials optionally consist of an aluminium alloy of type AA1xxx, AA3xxx, AA5xxx or AA8xxx, the manufacturing processes for which are well known.

According to a further embodiment, lower greenhouse gas emissions can be achieved provided that the battery cell housing is made of an aluminium alloy of type AA1050, AA1100, AA1200, AA3003, AA3004, AA3104, AA3005, AA3105, AA5005, AA5052, AA5454, AA5754, AA5182, AA5083, AA5086, AA8006, AA8008, AA8010, AA8011, AA8111, AA8021, AA8026, AA8050 or AA8079. Different production processes for the cylindrical battery cell housing can be used with the specified alloy types. For example, the lower-alloyed aluminium alloy of type AA1xxx is suitable for impact extrusion processes, while aluminium alloys of type AA3003, AA3004, AA3104, AA3005 or AA3105 provide high degrees of forming in the manufacture of battery cell housings, for example from sheet metal cut-outs, but also provide good to very good welding properties. At the same time, the alloy types AA3004, AA3104, AA3005 or AA3105 are particularly recyclable and enable high proportions of recycled material. The higher magnesium contents of aluminium alloy types AA5005, AA5052, AA5454, AA5754, AA5182, AA5083 or AA5086 not only exhibit excellent forming properties, but also provide particularly high yield strengths even in soft condition, so savings potentials in terms of greenhouse gas emissions can be utilised to the maximum extent due to the lower wall thicknesses of the battery cell housing jacket. At the same time, the alloy types AA5052, AA,5454, AA5754, AA5182, AA5083 and AA5086 allow a high proportion of recycled material due to their chemical composition.

Alloy types AA8006, AA8008, AA8010, AA8011, AA8111, AA8021, AA8026, AA8050 or AA8079 not only allow higher recycling contents to be achieved thanks to their wider alloy windows compared to 1xxx alloys but also enable higher strengths. In particular, the alloys are suitable for the absorption of scrap containing iron due to the high permissible iron content.

The aluminium material of the battery cell housing preferably has a yield strength R_{p0.2} of at least 100 MPa, preferably at least 150 MPa, particularly preferably at least 200 MPa. Soft aluminium materials with yield strengths R_{p0.2} of less than 100 MPa often allow particularly high degrees of forming but require higher wall thicknesses compared to the standard steel material to provide sufficient strength. From a yield strength of 100 MPa, savings in greenhouse gas emissions can be achieved with respect to an identical battery cell format mainly through savings in greenhouse gas emissions in aluminium production, in particular by using external scrap and primary aluminium, which contains a high proportion of primary metal produced with renewable energies. Higher yield strengths of at least 150 MPa or at least 200 MPa allow for additional material savings in addition to these savings, which also have a positive impact on the reduction of greenhouse gas emissions.

The greenhouse gas emissions for primary aluminium used in the European Union (EU) amount to an average of 8.6 kg_{CO2e}/kg_{Al-material}. If the aluminium material of the battery cell housing therefore preferably consists at least partially of a primary aluminium, the amount of CO₂ emitted per kg aluminium material of the battery cell housing during its manufacture is a maximum of 6.7 kg_{CO2e}/kg_{Al}, preferably a maximum of 5 kg_{CO2e}/kg_{Al}, particularly preferably a maximum of 4 kg_{CO2e}/kg_{Al}, and significant reductions in greenhouse gas emissions can also be achieved via the primary metal content. Corresponding values for the greenhouse gas emissions per kg of primary aluminium can be achieved by using CO₂-neutral energy, preferably renewable energy, during production, in particular renewable electricity. A maximum of 4 kg_{CO2e}/kg_{Al} is achieved if the primary metal is produced entirely using renewable energies, i.e. CO₂-neutral energies.

If, during the manufacture of the aluminium material of the battery cell housing, the greenhouse gas emissions per kg aluminium material of the battery cell housing amount to a maximum of 4 kg_{CO2e}/kg_{Al-material}, preferably a maximum of 3 kg_{CO2e}/kg_{Al-material}, particularly preferably a maximum of 2 kg_{CO2e}/kg_{Al-material}, the ratio CO₂ₑ/R_{p0.2} according to the invention of a maximum of 1.8% kg_{CO2e}/(MPa*kg_{Al-material}) can also be achieved with less solid aluminium materials, such as AA1xxx alloys. The proportion of external scrap and/or post-consumer scrap must be selected accordingly for this purpose.

According to a further teaching of the present invention, the above-mentioned object of providing a method for manufacturing a battery cell housing according to the invention is achieved in that the method comprises forming the aluminium material and preferably comprises deep drawing, wall-ironing, extrusion pressing, extrusion or extrusion pressing or roll forming of the aluminium material. Deep drawing, wall-ironing, extrusion or impact extrusion are forming processes that enable the economical production of the battery cell housings. At the same time, however, the manufacturing processes also set limits for the use of specific aluminium alloys. For example, impact extrusion processes of softer aluminium wrought alloys such as AA1050 are preferred, while AA6xxx alloys are mainly used for extrusion.

A method for manufacturing cylindrical battery cell housings which particularly efficiently avoids greenhouse gas emissions can be provided in that the aluminium material of the battery cell housing is manufactured at least 30%, preferably at least 60% and particularly preferably 100% from primary aluminium produced with CO₂-neutral energy. By using 100% primary aluminium produced with CO₂-neutral energy, the greenhouse gas emissions are reduced from 8.6 to 4 kg_{CO2e}/kg_{Al} for the correspondingly produced primary aluminium compared to the primary metal consumed on average in the EU, corresponding to a reduction of more than 50%.

According to a further embodiment, the aluminium material is manufactured at least 40%, preferably at least 70% from external scrap and/or post-consumer scrap, wherein internal scrap can optionally also be used to manufacture the aluminium material. Internal scrap has cumulative greenhouse gas emissions of 0.3 kg_{CO2e}/kg_{Al-material} for the production of the aluminium material from primary metal, for example, due to the production and further processing that has already taken place. Nevertheless, taking these metal sources into account helps to increase the efficiency of manufacturing the cylindrical battery cell housings, as material consumption is significantly reduced by remelting the internal scrap and waste is avoided. External scrap and/or post-consumer scrap contribute significantly to reducing the greenhouse gas emissions of the aluminium material, as these only generate greenhouse gas emissions of 0.5 kg_{CO2e}/kg_{Al-material}. It is therefore desirable to have as high a proportion of this scrap as possible.

According to a further configuration, a slug is first manufactured from the aluminium material, the slug being impact extruded into a cup-shaped, cylindrical battery cell housing blank. From the cup-shaped battery cell housing blank, the cylindrical battery cell housing having a battery cell housing jacket and a battery cell housing bottom is finally formed by means of at least one further forming step, preferably by wall-ironing, wherein aluminium alloys of type AA1xxx, AA3xxx, but also AA6xxx are preferably used for the aluminium material. Subsequently, a battery cell housing lid can also be manufactured from a sheet metal cut-out, for example in the form of a punched part, and the cylindrical battery cell housing can be closed with the battery cell housing lid after its assembly.

In an alternative method for manufacturing the battery cell housing, an aluminium strip is first manufactured from the aluminium material by rolling, from which a cylindrical battery cell housing having a battery cell housing jacket and a battery cell housing bottom, for example directly from the aluminium strip or from sheet metal cut-outs from the aluminium strip, is manufactured by means of deep-drawing and wall-ironing processes, wherein aluminium alloys of type AA1xxx, AA3xxx, AA5xxx or AA8xxx should preferably be used. The production steps of deep drawing or wall-ironing are tried-and-tested industrial process steps that can be carried out in a highly automated manner with low energy consumption, i.e. without complex annealing processes. This process is therefore also suitable for efficient production of the cylindrical battery cell housings.

Also starting from an aluminium strip, an aluminium strip can initially also be manufactured from the aluminium material by rolling according to a further alternative variant. A roll-forming method is used to form a roll-formed battery cell housing jacket from the aluminium strip, which battery cell housing jacket has a cylindrical cross-section at least in areas, and the battery cell housing jacket is joined in the longitudinal direction, preferably in a positive-locking, frictional and/or material-bonded manner. The cylindrical battery cell housing jacket is then cut to length and joined with a battery cell housing base made from a sheet metal cut-out made from an aluminium strip made from the same or a different aluminium material in a positive-locking, frictional and/or material-bonded manner, wherein aluminium alloys of type AA1xxx, AA3xxx, AA5xxx or AA8xxx are preferably used. Roll forming, longitudinal seam joining and cutting as well as joining battery cell housing lids are also industrially proven processes that lead to advantageous properties of the battery cell housing using the above-mentioned aluminium alloys. At the same time, the above-mentioned processes are also particularly energy-efficient, so greenhouse gas emissions continue to be dominated by the manufacturing process of the aluminium materials.

According to a further alternative embodiment, a tube made of the aluminium material is extruded, which is optionally cut to length and, after at least one optional processing step for providing the finally formed battery cell housing jacket with a battery cell housing base made of a sheet metal cut-out made of an aluminium strip made of the same or a different aluminium material, is preferably joined in a positive-locking, frictional and/or material-bonded manner, wherein aluminium alloys of types AA3xxx, AA6xxx or AA8xxx are preferably used.

In order to provide a finished cylindrical battery cell, the cup-shaped battery cell housings are closed with a battery cell housing lid made of a sheet metal cut-out made of an aluminium material during the cell assembly according to a further embodiment. In the case of tubular cell housings, the cell housing jacket is closed on both sides with a lid for each side during cell assembly. Here, too, positive-locking, frictional and/or material-bonded joining methods can preferably be used to join the battery cell housing lid.

Finally, the object set out above is achieved by using an aluminium material to manufacture a cylindrical battery cell housing, wherein the aluminium material is a ratio of the amount of greenhouse gases emitted during the manufacture of the aluminium material expressed in kgCO₂ₑ per
kg_{Al-material} to yield strength R_{p0.2} of the aluminium material in MPa of
CO₂ₑ/R_{p0.2}≤1.9% kg_{CO2e}/(MPa*kg_{Al-material}),
preferably CO₂ₑ/R_{p0.2}≤1.6% kg_{CO2e}/(MPa*kg_{Al-material},
particularly preferably CO₂ₑ/R_{p0.2}≤1.2% kg_{CO2e}/(MPa*kg_{Al-material}) or
CO₂ₑ/R_{p0.2}≤1.0% kg_{CO2e}/(MPa*kg_{Al-material}).

The use of the aluminium material according to the invention ensures a saving in greenhouse gas emissions compared to the current standard material of nickel-plated steel strips, so the CO2 footprint of the cylindrical battery cell housing can be further reduced while simultaneously providing a lower weight of the battery cell and better heat conduction.

### BRIEF DESCRIPTION OF THE DRAWINGS

The invention is described in greater detail below using exemplary embodiments in connection with the drawing, The drawing shows in

FIG. 1 is a schematic representation of a battery cell in a pouch design with a cylindrical battery cell housing,

FIG. 2 is a flowchart of a method for manufacturing a cylindrical battery cell housing by means of impact extrusion according to a first embodiment,

FIG. 3 is a flowchart of a method for manufacturing a cylindrical battery cell housing by deep drawing and wall-ironing a cut-out of an aluminium strip according to a second embodiment,

FIG. 4 is a flowchart for manufacturing a cylindrical battery cell housing by roll forming and longitudinal seam joining according to a third embodiment and in

FIG. 5 is a flow chart for manufacturing a prismatic battery cell housing by extruding a prismatic tube according to a fourth embodiment.

### DETAILED DESCRIPTION

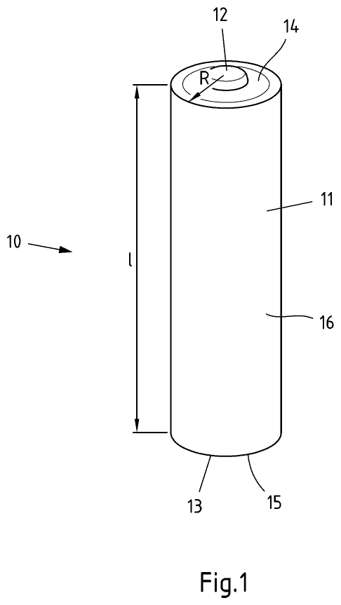

First FIG. 1 shows, in a schematic representation, a battery cell 10 with cylindrical battery cell housing 11. The battery cell 10 has, in addition to the battery cell housing 11, an anode terminal 12 and a cathode terminal 13. As already described above, the cylindrical battery cell housing 11 has two battery cell housing lids 14 and 15 as well as a battery cell housing jacket 16. In addition, FIG. 1 shows the form data important for the format of the cylindrical battery cell, the length 1 and the radius R.

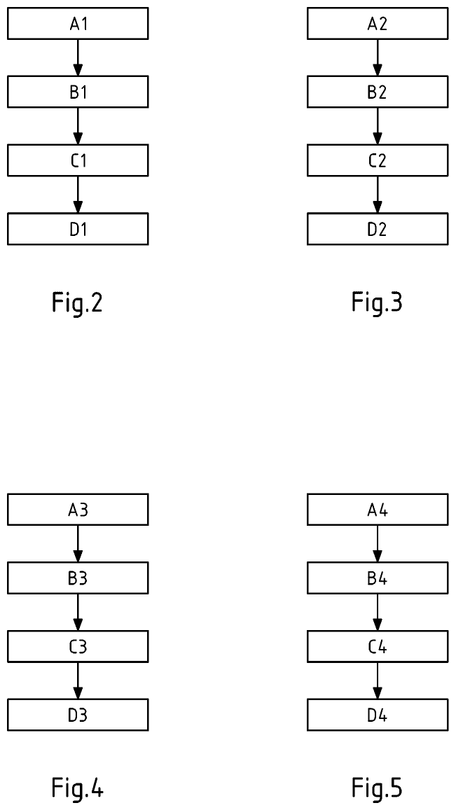

FIG. 2 is a schematic view of a manufacturing method of an embodiment. According to step A1, a slug is first manufactured from an aluminium material. The production of a slug can, for example, be carried out by sawing a rod having a corresponding diameter. Alternatively, slugs can be produced from rolling or casting belt production, wherein the slugs are punched from the rolling or casting belt and then surface treated and optionally annealed. The slug is then inserted into an impact extrusion tool and impact extruded into a cylindrical battery cell housing blank by means of impact extrusion in accordance with step B1. This is reworked in step C1 by at least one manufacturing step, for example cutting or wall-ironing to form the cylindrical battery cell housing 11 with battery cell housing base 15 and battery cell housing jacket 16, and is ready for cell assembly. In step D1, the battery cell housing lid 14 is mounted during cell assembly and joined with the battery cell housing jacket 16 in a positive-locking, frictional and/or material-bonded manner.

The starting point of the embodiments illustrated in FIG. 3 and FIG. 4 is an aluminium strip, which is provided in step A2 or A3 respectively.

For example, the aluminium strip can be manufactured by the following steps:
Casting a rolling ingot from an aluminium alloy,
Optionally homogenising the rolling ingot,
Hot rolling the rolling ingot to form a hot-rolled strip,
Cold rolling the hot rolled strip with optional intermediate annealing.

After cold rolling, the strips may be in the states H12, H14, H16, H18 or H19. However, the cold rolling can optionally be followed by a heat treatment of the strip in the form of a state annealing, preferably in the form of reverse annealing. After the reverse annealing, the yield strength values R_{p0.2} are barely reduced. However, the possible degrees of forming are significantly improved in the H24 state, for example.

Alternatively, the aluminium strip in step A2 or A3 can also be provided by continuous casting, optionally using twin-roll casters or twin-belt casters, which enable large production capacities. After the casting belt has been cast, for example, cold rolling takes place at the final thickness of the aluminium strip.

According to FIG. 3, in step B2, a cylindrical battery cell housing having a battery cell housing jacket and a battery cell housing base is manufactured from the rolled aluminium strip by deep drawing and wall-ironing processes, wherein aluminium alloys of type AA1xxx, AA3xxx, AA5xxx or AA8xxx are preferably used. The deep drawing and wall-ironing processes preferably take place on blanks of the aluminium strip but can also be carried out in subsequent composite tools on the aluminium strip. In step C2, a further forming step is optionally carried out to achieve the final geometry of the cylindrical battery cell housing 11 including the battery cell housing base 15 and battery cell housing jacket 16. In step D2, the battery cell housing lid 14 is mounted during cell assembly and joined with the battery cell housing jacket 16 in a positive-locking, frictional and/or material-bonded manner.

According to FIG. 4, a roll-formed battery cell housing jacket, which has a cylindrical cross-section at least in areas, is formed from the rolled aluminium strip by means of a roll-forming method in step B3. The battery cell housing jacket is then joined in the longitudinal direction, preferably in a positive-locking, frictional and/or material-bonded manner, and cut to length in step B3, wherein the battery cell housing jacket can optionally also be joined with a longitudinal seam only after cutting. In step C3, a cut battery cell housing base 15 is joined in a positive-locking, frictional and/or material-bonded manner to the battery cell housing shell 16 from a sheet metal cut-out made from an aluminium strip made from the same or a different aluminium material, wherein aluminium alloys of type AA1xxx, AA3xxx, AA5xxx or AA8xxx are preferably used for the battery cell housing shell 16 or the battery cell housing lids 14 and 15. In step D3, the battery cell housing lid 14 is mounted during cell assembly and joined with the battery cell housing jacket 16 in a positive-locking, frictional and/or material-bonded manner. Steps C3 and D3 can optionally be performed during cell assembly.

The cylindrical battery cell housings 11, which can be manufactured with the preceding methods, were examined with regard to the possibilities for saving greenhouse gas emissions. The following assumptions were made. Greenhouse gas emissions are mainly dominated by the provision of aluminium alloys, particularly when primary aluminium is used. For sheet metal production, as a rule only 0.4 kg_{CO2e}/kg_{Al-material} is generated. In the global energy mix, on the other hand, the production of primary aluminium emits 16 kg_{CO2e}/kgof_{Al-material}. On the other hand, primary aluminium consumed in the European Union up to the production of the rolling bar has an emission rate of only 8.6 kg_{CO2e}/kgof_{Al-material}. In the following, it is assumed for the calculation that internal scrap from primary metal with a CO₂ equivalent of 8.6 kg_{CO2e}/kg_{Al-material} is used and an average emission of 0.3 kg_{CO2e}/kg_{Al-material} is used for its processing, so that these are evaluated with an emission ratio of 8.9 kg_{CO2e}/kg_{Al-material}. External scrap and post-consumer scrap are taken into account at 0.5 kg_{CO2e}/kg_{Al-material}. If primary aluminium is produced with greenhouse gas emissions from neutral energies alone, this results in greenhouse gas emissions of only 4 kg_{CO2e}/kg_{Al-material}. (see International Aluminium Association: https://international-aluminium.org/statistics/greenhouse-gas-emissions-intensity-primary-aluminium/)

In Tables 1 and 2, the relationships represented in equation (15) with respect to embodiments according to the invention and comparative examples have now been examined. Table 1 contains embodiments according to the invention while Table 2 contains comparative examples.

The first three columns of both tables indicate the alloy designation, the tempering condition and the tested yield strength. This is the minimum yield strength R_{p0.2} according to DIN EN 485-2 of the aluminium alloy in the respective tempered state. There are then 5 columns which indicate the proportions of the respective primary metal and/or the internal and external scrap of the examined aluminium materials. The heading CO₂ₑ, in the 6th column is the CO₂ footprint of the aluminium material, including 0.4 kg_{CO2e}/kg_{Al-material} for the manufacture of the battery cell housing, and from this value the ratio to the yield strength in the 7th column has been determined.

The specified greenhouse gas savings result from equation (15), taking into account the nickel-plated reference material steel type AISI 1020 at 2.4 kg_{CO2e}/kgₛₜₑₑₗ, a yield strength R_{p0.2} of 350 MPa and the battery cell format 18650 with the wall thicknesses of the battery cell housing shell or s_{Steel}=0.185 mm the lids s_{Steel,D}=0.22 mm and an internal radius Rᵢ=8.815 mm at a length L=65 mm.

It was shown that all aluminium materials examined from the aluminium alloys of type AA1xxx, AA3xxx, AA5xxx and AA8xxx can provide a reduction in greenhouse gas emissions compared to the current reference material, a nickel-plated steel of type AISI 1020 manufactured with an emission rate of 2.4 kg_{CO2e}/kg steel at a ratio of CO₂ₑ/R_{p0.2} of maximum 1.9% kg_{CO2e}/(MPa*kg_{Al-material}), provided that specifications are made for the yield strength R_{p0.2} as well as for the origin of the primary aluminium and/or the use of the scrap components. As already stated above, starting from a cylindrical battery cell housing of the format 18650 made of the above-mentioned steel with the wall thicknesses of the battery cell housing shell or s_{Steel}=0.185 mm the lids s_{Steel,D}=0.22 mmand an internal radius Rᵢ=8.815 mm at a length L=65 mm, a saving of greenhouse gas emissions of more than 4% is achieved.

Embodiments 1 to 11 according to the invention have a ratio of CO₂ₑ/R_{p0.2} of a maximum of 1.9% to more than 1.6% kg_{CO2e}/(MPa*kg_{Al-material}), such that a saving of at least 4% in greenhouse gas emissions in kg_{CO2e}/kg_{Al-material} is achieved taking into account the format 18650 specified above. It can be seen that in order to achieve the stated emission savings, external scrap proportions of at least 40% must be used in the production, provided that primary metal is used with the energy requirement of the primary metals currently processed in the EU (embodiments 1 and 2). In addition, thanks to high strengths with yield strengths R_{p0.2} of more than 200 MPa, the total emissions for the cylindrical battery cell housing can in turn be brought into the desired range by using less material. This is shown by embodiments 2, 9, 20 and 35, whose aluminium materials have an emission rate of more than 4 kg_{CO2e}/kg_{Al-material}.

Embodiments 12 to 22 have a ratio of CO₂ₑ/R_{p0.2} of a maximum of 1.6% to more than 1.2% kg_{CO2e}/(MPa*kg_{Al-material}) and therefore achieve savings in greenhouse gas emissions of more than 25%. Such savings are achieved primarily through the use of CO₂-neutral primary aluminium produced using renewable energy in combination with the use of external scrap, as shown in embodiments 12, 13, 15 to 19 and 21 and 22. Embodiments 14 and 20 show that with very high yield strengths of the aluminium material above 200 MPa, both the partial use of primary metal with a CO₂ footprint of currently 8.6 kg_{CO2e}/kg_{Al-material} of the primary metal used in the EU, see embodiment 14, and a use of primary aluminium produced exclusively with renewable energy, such as in embodiment 20, achieves the above-mentioned reduction in greenhouse gas emissions.

Embodiments 23 to 32 show that even higher savings in greenhouse gas emissions are possible, since with a ratio of CO₂ₑ/R_{p0.2} of maximum of 1.2% kg_{CO2e}/(MPa*kg_{Al-material}) taking into account the above-mentioned reference material and the battery cell format used, the saving is more than 40% for embodiments 23 to 29 and more than 50% for embodiments 29 to 34 with a ratio of CO₂ₑ/R_{p0.2} of a maximum of 1.0% kg_{CO2e}/(MPa*kg_{Al-material}).

Furthermore, it can be read from the exemplary embodiments that for an emitted amount of CO₂ per kg aluminium material of the battery cell housing between 3 and 4 kg_{CO2e}/kg_{Al-material}, aluminium materials with at least 185 MPa are used in order to achieve the saving in greenhouse gas emissions. Lower greenhouse gas emissions in the manufacture of the aluminium material of the battery cell housing of preferably a maximum of 3 kg_{CO2e}/kg_{Al-material} or particularly preferably a maximum of 2 kg_{CO2e}/kg_{Al-material} allow the use of softer aluminium materials with yield strengths Rp_{0.2} less than 185 MPa, for example a maximum of 180 MPa, as shown in embodiments 22 and 24, despite high savings in the greenhouse gas emissions.

Although the embodiments of the invention in Table 1 do not show the proportions of internal scrap, their use to achieve CO₂ savings is nevertheless important and sensible, since, as already stated, they reduce the material use of primary aluminium overall. In the event that the CO₂ emissions for the aluminium material from which the internal scrap is produced are significantly reduced, the CO₂ emission contributions of the internal scrap are also reduced.

In principle, for example, by increasing the proportions of external scrap to more than 70%, for example 85% or even more than 90%, compensation can be made possible in the embodiments shown for the use of internal scrap.

An examination of other battery formats, for example a 4680 format, showed that only very small effects on the possible CO₂ savings at a specified ratio of CO₂ₑ/R_{p0.2} of a maximum of 1.9% kg_{CO2e}/(MPa*kg_{Al-material}) are associated with the change of the battery format. For larger volume formats, such as 4680, there are higher savings in the single-digit percentage range for greenhouse gas emissions compared to the smaller format 18650.

The embodiments according to the invention can therefore be used to specify aluminium materials for battery cell housings which allow significant savings in greenhouse gas emissions during the manufacture of the battery cell housings and nevertheless provide the advantages of the use of aluminium materials for battery cell housings.

Comparative examples are given in Table 2. In particular, it can be seen that with low values for the yield strength R_{p0.2} of less than 100 MPa, even high proportions of 70% of external scrap do not lead to greenhouse gas savings compared to the reference material steel, see comparative examples 1 and 2. The same applies to the use of ultra-high-strength materials using energy with global greenhouse gas emissions of 16 kg_{CO2e}/kg_{Al} dominated by coal electricity, as shown by comparative examples 16 and 17, which exhibit CO₂ₑ/R_{p0.2} ratios that are significantly too high.

TABLE 1
Embodiments according to the invention

| | | | Ratio of | | | | | | |
|---|---|---|---|---|---|---|---|---|---|
| | | | primary metal | Ratio of | Ratio of | | | | |
| | | | in [%] | internal | external | | | | |
| | | | Manufactured | scrap [%] | scrap [%] | | | | |
| | | | from | energy | energy | CO₂ₑ | | | |
| AA | Temper | R_{p0.2} | Renewable | mix | mix | [kg_{CO2e}/ | | CO₂ₑ/R_{p0.2} | |
| alloy | state | (MPa) | energy | Ø EU | Ø global | kg_{Al-material}] | | [%] | No. |
| 5005 | H19 | 185 | | 30 | | 70 | 3.33 | 1.80 | 1 |
| 5182 | H19 | 320 | | 60 | | 40 | 5.76 | 1.80 | 2 |
| 1050 | H18 | 120 | 30 | | | 70 | 1.95 | 1.63 | 3 |
| 3003 | H19 | 180 | 60 | | | 40 | 3 | 1.67 | 4 |
| 3004 | H24 | 170 | 60 | | | 40 | 3 | 1.76 | 5 |
| 3105 | H18 | 180 | 60 | | | 40 | 3 | 1.67 | 6 |
| 5005 | H24 | 110 | 30 | | | 70 | 1.95 | 1.77 | 7 |
| 5052 | H14 | 180 | 60 | | | 40 | 3 | 1.67 | 8 |
| 5754 | H18 | 250 | 100 | | | | 4.4 | 1.76 | 9 |
| 5182 | O | 110 | 30 | | | 70 | 1.95 | 1.77 | 10 |
| 8011 | H14 | 110 | 30 | | | 70 | 1.95 | 1.77 | 11 |
| 1050 | H19 | 130 | 30 | | | 70 | 1.95 | 1.50 | 12 |
| 3003 | H14 | 125 | 30 | | | 70 | 1.95 | 1.56 | 13 |
| 3004 | H19 | 240 | | 30 | | 70 | 3.33 | 1.39 | 14 |
| 3005 | H14 | 150 | 30 | | | 70 | 1.95 | 1.30 | 15 |
| 3105 | H14 | 130 | 30 | | | 70 | 1.95 | 1.50 | 16 |
| 5052 | H24 | 150 | 30 | | | 70 | 1.95 | 1.30 | 17 |
| 5052 | H18 | 240 | 60 | | | 40 | 3 | 1.25 | 18 |
| 5083 | O | 125 | 30 | | | 70 | 1.95 | 1.56 | 19 |
| 5083 | H14 | 280 | 100 | | | | 4.4 | 1.57 | 20 |
| 5083 | H32 | 215 | 60 | | | 40 | 3 | 1.40 | 21 |
| 8011 | H18 | 145 | 30 | | | 70 | 1.95 | 1.34 | 22 |
| 3003 | H18 | 170 | 30 | | | 70 | 1.95 | 1.15 | 23 |
| 3004 | H24 | 170 | 30 | | | 70 | 1.95 | 1.15 | 24 |
| 3105 | H19 | 190 | 30 | | | 70 | 1.95 | 1.03 | 25 |
| 5005 | H19 | 185 | 30 | | | 70 | 1.95 | 1.05 | 26 |
| 5754 | H14 | 190 | 30 | | | 70 | 1.95 | 1.03 | 27 |
| 5182 | H19 | 320 | | 30 | | 70 | 3.33 | 1.04 | 28 |
| 5083 | H14 | 280 | | 30 | | 70 | 3.33 | 1.19 | 29 |
| 3004 | H19 | 240 | 30 | | | 70 | 1.95 | 0.81 | 30 |
| 3005 | H18 | 200 | 30 | | | 70 | 1.95 | 0.98 | 31 |
| 5052 | H18 | 240 | 30 | | | 70 | 1.95 | 0.81 | 32 |
| 5182 | H19 | 320 | 60 | | | 40 | 3 | 0.94 | 33 |
| 5083 | H14 | 280 | 30 | | | 70 | 1.95 | 0.70 | 34 |
| 5182 | H19 | 320 | | | 30 | 70 | 5.55 | 1.73 | 35 |

TABLE 2
Comparative examples

| | | | Ratio of | | | | | | | |
|---|---|---|---|---|---|---|---|---|---|---|
| | | | primary metal | Ratio of | | | | | | |
| | | | in [%] | internal | Ratio of | | | | | |
| | | | Manufactured | scrap [%] | external scrap [%] | | | | | |
| | | | from | energy | energy | | | CO₂ₑ | | |
| AA | Temper | R_{p0.2} | Renewable | mix | mix | | | [kg_{CO2e}/ | CO₂ₑ/R_{p0.2} | |
| alloy | state | (MPa) | energy | Ø EU | Ø global | | | kg_{Al-material}] | [%] | No. |
| 1050 | H14 | 85 | 60 | | | 40 | | 6.36 | 7.48 | 1 |
| 1050 | H14 | 85 | 30 | | | | 70 | 1.95 | 2.29 | 2 |
| 1050 | H18 | 120 | 60 | | | | 40 | 3 | 2.50 | 3 |
| 3003 | H14 | 125 | 60 | | | | 40 | 3 | 2.40 | 4 |
| 3003 | H14 | 125 | | 30 | | | 70 | 3.33 | 2.66 | 5 |
| 3003 | H18 | 170 | | 30 | | | 70 | 3.33 | 1.96 | 6 |
| 3004 | H14 | 180 | | 30 | | | 70 | 3.33 | 1.85 | 7 |
| 3004 | H18 | 230 | | 60 | | | 40 | 5.76 | 2.50 | 8 |
| 3005 | H18 | 200 | 100 | | | | | 4.4 | 2.20 | 9 |
| 3005 | H19 | 210 | | 60 | | | 40 | 5.76 | 2.74 | 10 |
| 3005 | H19 | 210 | | | 30 | | 70 | 5.55 | 2.64 | 11 |
| 5754 | H24 | 160 | | 30 | | | 70 | 3.33 | 2.08 | 12 |
| 5083 | H14 | 280 | | 60 | | | 40 | 5.76 | 2.06 | 13 |
| 5083 | H24 | 250 | | | 30 | | 70 | 5.55 | 2.22 | 14 |
| 8011 | H18 | 145 | 60 | | | | 40 | 3 | 2.07 | 15 |
| 3005 | H19 | 210 | | | 100 | | | 16.4 | 7.81 | 16 |
| 5182 | H19 | 320 | | | 100 | | | 16.4 | 5.13 | 17 |
| 5182 | H19 | 320 | | | 60 | | 40 | 10.2 | 3.19 | 18 |
| 5083 | O | 125 | | | 60 | | 40 | 10.2 | 8.16 | 19 |
| 5083 | O | 125 | | | 30 | | 70 | 5.55 | 4.44 | 20 |

All references, including publications. patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Cylindrical battery cell housing,
wherein
the cylindrical battery cell housing has an aluminium material with a ratio of the amount of carbon dioxide (CO₂ₑ) emitted during the manufacture of the aluminium material in kgCO₂ₑ per kg_{Al-material} to the yield strength Rp0.2 of the aluminium material in MPa of CO₂ₑ/R_{p0.2}≤1.9% kg_{CO2e}/(MPa*kg_{Al-material}),
preferably CO₂ₑ/R_{p0.2}≤1.6% kg_{CO2e}/(MPa*kg_{Al-material}),
particularly preferably CO₂ₑ/R_{p0.2}≤1.2% kg_{CO2e}/(MPa*kg_{Al-material}) or
CO₂ₑ/R_{p0.2}≤1.0% kg_{CO2e}/(MPa*kg_{Al-material}), wherein the yield strength R_{p0.2} is measured in accordance with DIN EN ISO 6892-1 at room temperature.

2. Battery cell housing according to claim 1,
wherein
the cylindrical battery cell housing has a housing jacket with an outer diameter of more than 14 mm, preferably more than 17.5 mm, particularly preferably more than 22 mm, wherein the length of the cylindrical battery cell housing is optionally at least 40 mm.

3. Battery cell housing according to claim 1,
wherein
the aluminium material is an aluminium wrought material.

4. Battery cell housing according to claim 1,
wherein
the aluminium material is a naturally hard aluminium wrought material and optionally has an aluminium alloy of type AA1xxx, AA3xxx, AA5xxx or AA8xxx.

5. Battery cell housing according to claim 1,
wherein
the battery cell housing is an aluminium alloy of type AA1050, AA1000, AA1200, AA3003, AA3004, AA3104, AA3005, AA3105, AA5005, AA5052, AA5454, AA5754, AA5182, AA5083, AA5086, AA8006, AA8008, AA8010, AA8011, AA8111, AA8021, AA8026, AA8050 or AA8079.

6. Battery cell housing according to claim 1,
wherein
the aluminium material in the battery cell housing has a yield strength R_{p0.2} of more than 100 MPa, preferably 150 MPa, particularly preferably more than 200 MPa.

7. Battery cell housing according to claim 1,
wherein
the aluminium material consists at least partially of a primary aluminium, the amount of CO₂ emitted per kg aluminium material of the battery cell housing during manufacture of which is a maximum of 6.7 kg_{CO2e}/kg_{Al}, preferably a maximum of 5 kg_{CO2e}/kg_{Al}, particularly preferably a maximum of 4 kg_{CO2e}/kg_{Al}.

8. Battery cell housing according to claim 1,
wherein
₂ emitted per kg aluminium material of the battery cell housing is a maximum of 4 kg_{CO2e}/kg_{Al-material}, preferably a maximum of 3 kg_{CO2e}/kg _{Al}, particularly preferably a maximum of 2 kg_{CO2e}/kg _{Al}.

9. Method for manufacturing a cylindrical battery cell housing according to claim 1,
wherein
the method comprises forming the aluminium material, preferably deep drawing, impact extrusion, extrusion or roll forming of the aluminium material.

10. Method according to claim 9,
wherein
the aluminium material is manufactured at least 30%, preferably at least 60% and particularly preferably 100% from primary aluminium produced with CO₂-neutral energy.

11. Method according to claim 9,
wherein
the aluminium material is manufactured from primary-based aluminium and at least 40%, preferably at least 70%, external scrap and/or post-consumer scrap, optionally with internal scrap also being used to manufacture the aluminium material.

12. Method according to claim 9,
wherein
a slug is first manufactured from the aluminium material, the slug is impact extruded into a cup-shaped, cylindrical battery cell housing blank and a battery cell housing jacket and a battery cell housing bottom are finally formed from the cup-shaped battery cell housing blank having the cylindrical battery cell housing by means of at least one further forming step, preferably by wall-ironing, wherein aluminium alloys of type AA1xxx, AA3xxx but also AA8xxx are preferably used for the aluminium material.

13. Method according to claim 9,
wherein
wall-ironing processes, wherein aluminium alloys of type AA1xxx, AA3xxx, AA5xxx or AA8xxx are preferably used or alternatively a roll-formed battery cell housing jacket is formed from the aluminium strip by means of a roll-forming process, which has a cylindrical cross-section at least in areas; the battery cell housing jacket is joined in the longitudinal direction, preferably in a positive-locking, frictional and/or material-bonded manner, the cylindrical battery cell housing jacket is cut to length and is joined in a positive-locking, frictional and/or material-bonded manner with a battery cell housing bottom made from a sheet metal cut-out made from an aluminium strip made from the same or another aluminium material, wherein aluminium alloys of type AA1xxx, AA3xxx, AA5xxx or AA8xxx are preferably used.

14. Method according to claim 9,
wherein
a tube made of the aluminium material is extruded, which tube is optionally cut to length and, after at least one optional processing step for providing the finally formed battery cell housing jacket, is joined with a battery cell housing bottom made of a sheet metal cut-out made of an aluminium strip made of the same or a different aluminium material in a positive-locking, frictional and/or material-bonded manner, wherein aluminium alloys of type AA1xxx, AA3xxx, AA5xxx, AA6xxx or AA8xxx should preferably be used.

15. Method according to claim 11,
wherein
the cup-shaped, cylindrical battery cell housing is preferably joined during the cell assembly with a battery cell housing lid made of a sheet metal cut-out made of an aluminium material in a positive-locking, frictional and/or material-bonded manner.

16. Use of an aluminium material for manufacturing a cylindrical battery cell housing according to claim 1,
wherein
the aluminium material has a ratio of the amount of carbon dioxide (CO₂ₑ) emitted during the manufacture of the aluminium material in kg_{CO2e} per
kg_{Al-material} to yield strength R_{p0.2} of the aluminium material in MPa of CO₂ₑ/R_{p0.2}≤1.9% kg_{CO2e}/(MPa*kg_{Al-material}),
preferably CO₂ₑ/R_{p0.2}≤1.6% kg_{CO2e}/(MPa*kg_{Al-material}),
particularly preferably CO₂ₑ/R_{p0.2}≤1.2% kg_{CO2e}/(MPa*kg_{Al-material}) or CO₂ₑ/R_{p0.2}≤1.0% kg_{CO2e}/(MPa*kg_{Al-material}).

17. Use of an aluminium material for manufacturing a cylindrical battery cell housing according to the method of claim 9,
wherein
₂ₑ) emitted during the manufacture of the aluminium material in kg_{CO2e} per kg_{Al-material} to yield strength R_{p0.2} of the aluminium material in MPa of ₂ₑ/R_{p0.2}≤1.9% kg_{CO2e}/(MPa*kg_{Al-material}),
₂ₑ/R_{p0.2}≤1.6% kg_{CO2e}/(MPa*kg_{Al-material}),
particularly preferably CO₂ₑ/R_{p0.2}≤1.2% kg_{CO2e}/(MPa*kg_{Al-material}) or ₂ₑ/R_{p0.2}≤1.0% kg_{CO2e}/(MPa*kg_{Al-material}).
